(19) United States
(12) Patent Application Publication
(10) Pub. No.: US 2009/0078522 A1
(43) Pub. Date: Mar. 26, 2009

(54) Hydrodynamic torque converter with coupling spring device for the piston

(75) Inventors: Stefan Jung, Kehl (DE); Bruno Mueller, Sasbach (DE); Stephan Maienschen, Baden-Baden (DE)

Correspondence Address: SIMPSON & SIMPSON, PLLC, 5555 MAIN STREET, WILLIAMSVILLE, NY, 14221-5406, US

(73) Assignee: Luk Lamellen und Kupplungsbau Betelligungs KG, Buehl (DE)

(21) Appl. No.: 12/290,756

(22) Filed: Nov. 3, 2008

Related U.S. Application Data
(63) Continuation of application No. PCT/DE07/00685, filed on Apr. 19, 2007.

(30) Foreign Application Priority Data
Apr. 5, 2006 (DE) DE102006020743.2

(51) Int. Cl. F16H 45/02

(52) U.S. Cl. 192/3.29

(57) ABSTRACT

A hydrodynamic torque converter with a driving pump wheel and a drive turbine wheel that is placed in a housing in such a way that it can rotate is fixed to the drive shaft of a drive unit, and is connected to the housing with a converter bridging coupling that has a piston which remains fixed, with the help of a coupling spring mechanism, but which can be rotated in an axial direction.

### CROSS-REFERENCE TO RELATED APPLICATIONS

This application is a Continuation of International Patent Application Serial No. PCT/DE2007/000685, filed on Apr. 19, 2007, which application claims the benefit of priority from German Patent Application Serial No. 10 2006 020 743.2, filed on May 4, 2006, which applications are incorporated herein by reference.

### FIELD OF THE INVENTION

The invention relates to a hydrodynamic torque converter with a driving impeller and a driven impeller which is rotatably disposed in a housing which is attachable to the output shaft of a drive unit, and provided with a torque converter lockup clutch which features a piston which is connected with the help of a coupling spring device non-rotatably, but movably with the housing in the axial direction.

### BACKGROUND OF THE INVENTION

In conventional torque converters, for instance, the piston is coupled with the help of preloaded leaf springs and coupled with the housing on drive side. The document U.S. Pat. No. 6,712,186 B1 depicts a hydrodynamic torque converter with a piston which is coupled by means of a tooth system without prestress with the housing. The U.S. Pat. No. 6,688,441 B1 document shows a hydrodynamic torque converter with a piston attached to the housing via a leaf spring.

### BRIEF SUMMARY OF THE INVENTION

The object of the invention is to provide a hydrodynamic torque converter in accordance with the description below, which can transmit larger torque than conventional torque converters.

The object is met with a hydrodynamic torque converter with a driving impeller and a driven turbine wheel which is rotatably disposed in a housing which is attachable to the output shaft of a drive unit, and having a torque converter lockup clutch which features a piston which is non-rotatably connected with the help of a coupling spring device, but is movably connected with the housing in the axial direction, wherein the piston is connected with the housing on the converter-side radially outside by means of the coupling spring device under axial prestress. Since the linking means takes place radially outside the housing, the radial design space of the torque converter lockup clutch can be omitted in the friction surface area, as a result of which the friction surface as well as the effective radius of the friction surface may be enlarged. Since the transmittable torque depends on the permissible surface pressure and the effectively acting friction lining surface, larger torque may be transmitted by enlarging the effective radius and friction surface. Furthermore, axial prestress can be achieved by linking the piston with the housing, for instance with a force of 300 Newton. Through this, the surface pressure may be increased advantageously. The converter can, for instance, be dimensioned for an engine torque of 400 Newton meter. This is advantageous, particularly because of radial expansion of the friction lining. It is advantageous in that this extension does not cause enlargement of housing dimensions of the hydrodynamic torque converter. Owing to the fact that the piston on converter side is connected with the housing, for instance, the effective radius of the friction lining can be enlarged by 10 to 12 mm, whereby the friction lining surface can be enlarged by approx. 10%.

A preferred exemplary embodiment of the hydrodynamic torque converter is characterized in that the coupling spring device is interposed between the piston and a converter-side cover of the housing, wherein the piston features a first rim with a first tooth system and the converter-side cover features a second rim with a second tooth system. Non-rotatable coupling of the piston with the housing can take place advantageously via the tooth systems and the coupling spring device. In addition, it is possible through the tooth systems to keep the coupling axially displaceable.

A further preferred exemplary embodiment of the hydrodynamic torque converter is characterized in that the coupling spring device features a drive synchronizer spring with V-shaped oppositely disposed spring elements, wherein the spring elements mesh with the first and second tooth system. The drive synchronizer spring of the coupling spring device can be formed of a suitable springy material, for instance, of a material with the initial CK75. The drive synchronizer spring can fulfill the task of a driving tab. In a particular case, the drive synchronizer spring can feature tooth systems complementary to the first and second tooth system which are in mesh with the latter and ensure coupling or synchronization of the piston. Therefore, the piston has the same speed of rotation as the housing of the hydrodynamic torque converter. In addition, the drive synchronizer spring can be formed as a spring-elastic element and abut on the corresponding rims of the piston and of the converter-side cover. As a result, the axial prestress of the piston can be applied against the friction lining of the torque converter lockup clutch. The functional manner is comparable with two diaphragm springs inside one another. It is moreover advantageous that the requirement of driving tab as well as axial press-on closure of the piston is fulfilled by a component, namely the driving tab or the drive synchronizer spring.

A further preferred exemplary embodiment of the hydrodynamic torque converter is characterized in that the coupling spring device features a diaphragm spring ring. Here, the object of prestress and driving tab effect is likewise met by means of one component.

A further preferred exemplary embodiment of the hydrodynamic torque converter is characterized in that the coupling spring device features a drive-side diaphragm spring which meshes with the first tooth system, and a converter-side diaphragm spring which meshes with the second tooth system, wherein the diaphragm springs are non-rotatably coupled with one another. In this case, the driving tab effect and prestress also occur via two diaphragm springs, wherein the attachment of individual diaphragm springs to the housing or piston occurs analogously. In contrast, the two easily manufactured diaphragm springs, for instance, are likewise non-rotatably coupled by suitable tooth systems.

A further preferred exemplary embodiment of the hydrodynamic torque converter is characterized in that die coupling spring device features a leaf spring. As a result, the leaf spring can be disposed directly between the piston and the output-side cover of the housing, so that the radial design space likewise can be omitted. The leaf spring can be attached by means of usual connection techniques, for instance, by a rivet. It is considerable that the coupling spring device features several such leaf springs.

A further preferred exemplary embodiment of the hydrodynamic torque converter is characterized in that the leaf spring is attached to a disk-shaped catch and piston. The disk-shaped catch can be coupled with the housing in the known manner, for instance, with the converter-side cover of the housing, for instance, via the second tooth system. To couple the disk-shaped catch with the piston again non-rotatably, the leaf spring can be attached to the piston and to the disk-shaped catch in the usual manner, for instance, by rivets.

A further preferred exemplary embodiment of the hydrodynamic torque converter is characterized in that the diaphragm spring ring meshes with the first and the second tooth system. By meshing with the tooth system, the piston can be sustained at the rotation speed of the housing. To be able to mesh with the first and the second tooth system, the diaphragm spring rings feature appropriately form-closed, adapted teeth on the tooth systems.

A further preferred exemplary embodiment of the hydrodynamic torque converter is characterized in that the diaphragm spring ring is attached to the housing via a splined disk carrier. The disk carrier can be attached to the housing in the usual manner, for instance, to the input-side cover of the housing. The disk carrier can feature cutouts, with which the tooth system of the diaphragm spring rings can mesh to transmit torque. In addition, the disk carrier can mesh with a corresponding tooth system of the piston, in order to couple it non-rotatably with the housing.

A further preferred exemplary embodiment of the hydrodynamic torque converter is characterized in that the diaphragm spring ring is insertable in the disk carrier by means of form-closure. The diaphragm spring ring can be inserted advantageously in the disk carrier under prestress analogously to a bayonet closure. As soon as the diaphragm spring ring again relaxes, it can be held by the disk carrier under form-closure.

The above specified task is moreover solved by a torque transmission device with a hydrodynamic torque converter, for torque transmission between a drive unit and a transmission, disposed in the power train of a motor vehicle, as described initially.

### BRIEF DESCRIPTION OF THE DRAWINGS

Further advantages features and details are derived from the following description with reference to the drawing, in which different exemplary embodiments are described in detail. The figures show the following:

FIG. 1 shows a longitudinal section of a conventional torque transmission device;

FIG. 2 shows a longitudinal section of a torque transmission device according to the invention, with a drive synchronizer spring;

FIG. 3 shows a three dimensional exploded view of skewed front of the torque transmission device from FIG. 2;

FIG. 4 shows a detail view of a longitudinal section of an exemplary embodiment of the torque transmission device with an input-side diaphragm spring and a converter-side diaphragm spring;

FIG. 5 shows a detail view of a further exemplary embodiment of a torque transmission device with a diaphragm spring ring;

FIG. 6 shows a detail view of a longitudinal section of a further exemplary embodiment of a torque transmission device with a leaf spring bonded to a disk-shaped catch;

FIG. 7 shows a detail view of a further sectional illustration of the disk-shaped carrier and the leaf spring of the torque transmission device in accordance with FIG. 6;

FIG. 8 shows detail view of a longitudinal section of a further torque transmission device with a leaf spring;

FIG. 9 shows a detail view of a further sectional illustration of the leaf spring of the torque transmission device in accordance with FIG. 8;

FIG. 10 shows the plan view of a longitudinal section of a further torque transmission device with a diaphragm spring ring and a disk carrier;

FIG. 11 shows a partially depicted plan in the perspective of arrow A from FIG. 10 on the diaphragm spring ring and piston of the torque transmission device in accordance with FIG. 10, before and after the assembly of the diaphragm spring ring; and,

FIG. 12 shows a partially depicted plan in the perspective of arrow A from FIG. 10 on the diaphragm spring ring and piston of the torque transmission device in accordance with FIG. 10, before and after the assembly of the diaphragm spring ring.

### DETAILED DESCRIPTION OF THE INVENTION

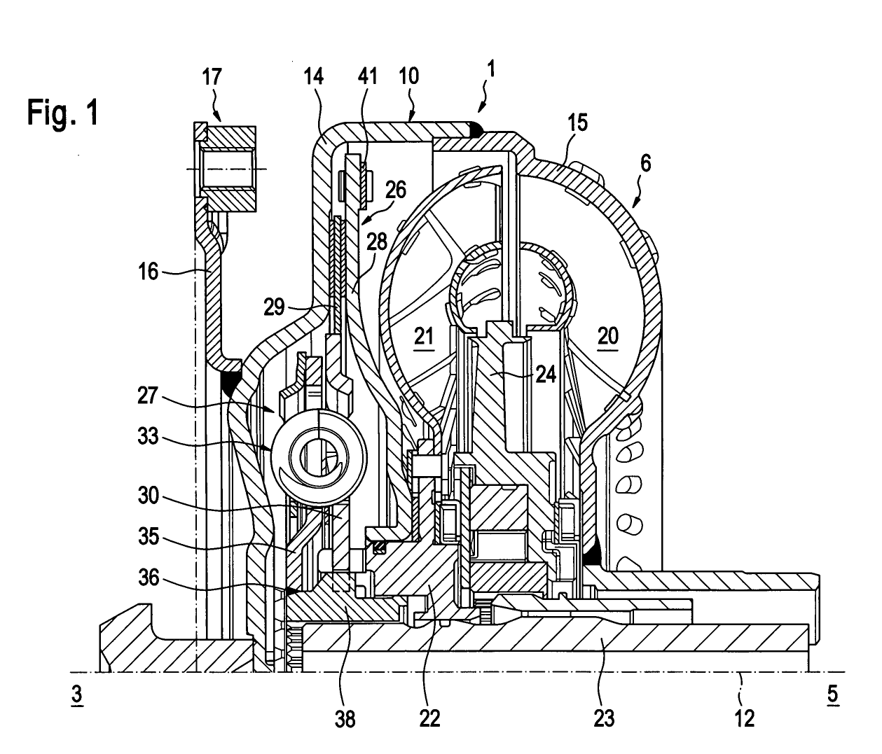

A part of power train 1 of a motor vehicle is depicted in FIG. 1. Hydrodynamic torque converter 6 is disposed between drive unit 3, in particular, of an internal combustion engine, from which a crankshaft and transmission 5 protrude. The crankshaft of internal combustion engine 3, for instance, is non-rotatably connected with housing 10 of torque converter 6, via a drive plate that is also designated as flex plate.

Housing 10 of torque converter 6 is rotatable about rotation axis 12 and is equipped with housing wall 14 near the drive and housing wall 15 far from the drive. On housing wall 14 near the drive, starter ring gear 17 is fixed with the help of connection plate 16 that extends radially outwards. Housing wall 15 far from the drive is combined in a module with impeller 20 of hydrodynamic torque converter 6.

Turbine wheel 21 is interposed between impeller 20 and housing wall 14 near the drive which is fixed on turbine wheel hub 22 with the help of rivet connection elements. Turbine wheel hub 22 is rotatably disposed on an output shaft or input shaft 23 of transmission 5. Guide vane 24 is interposed in the usual manner between turbine wheel 21 and impeller 20. Between turbine wheel 21 and housing wall 14 near the drive, torque converter lockup clutch 26 with torsional vibration damper 27 is likewise disposed in the usual manner. Torque converter lockup clutch 26 comprises piston 28 which is rotatably supported and is axially displaceable, radially outwardly on turbine wheel hub 22. Piston 28 features a friction surface radially outwards which is facing internal combustion engine 3 and is disposed opposite a further friction surface which is provided on the side facing away from internal combustion engine 3 on housing wall 14 near the drive. Friction disk 29 is interposed between the two friction surfaces which are connected non-rotatably with clutch disk 30.

Clutch disk 30 is coupled, in the usual manner, with damper flange 35 of torsional vibration damper 27 under interposition of energy storage elements 33, particularly of bow springs. Damper flange 35 is connected with damper hub 38 with the help of welded joint 36 in a form-closed manner. Damper hub 38 is again connected radially inside, non-rotatably with one end of input shaft 23 of transmission 5.

To prestress torque converter lockup clutch 26, piston 28 is coupled with a leaf spring 41. Coupling takes place in a required radial design space or coupling area between friction disk 29 of torque converter lockup clutch 26 and housing wall 14. Leaf spring 41 is attached to housing 10 of torque converter 6. The effective friction surface of friction disk 29 is also disposed radially within leaf spring 41 or coupling area of leaf spring 41 with piston 28.

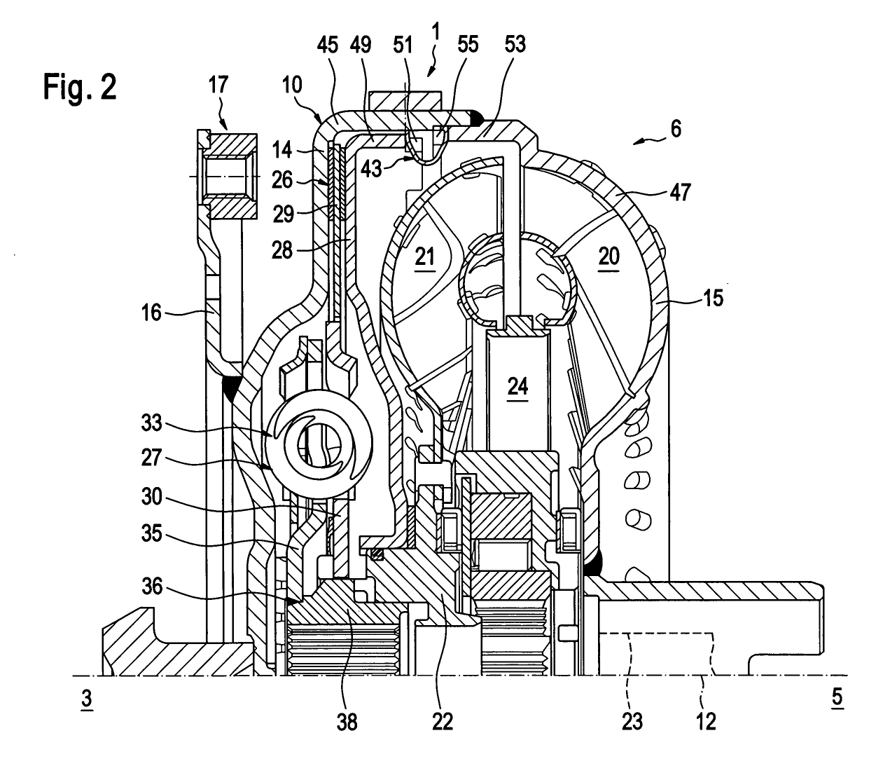

FIG. 2 shows a longitudinal section of torque converter 6 according to the invention with coupling spring device 43. In the following, differences from a known torque converter 6 are explained in accordance with FIG. 1, wherein same, similar and/or functionally similar components are provided with the same reference signs. Piston 28 is connected with housing 10 on converter side, radially outside by means of coupling spring device 43 under axial prestress.

Housing 10 features drive-side cover 45 and converter-side cover 47. In contrast to the illustration in accordance with FIG. 1, piston 28 is essentially disk-shaped and features a rim 49. First rim 49 of piston 28 features first tooth system 51. Converter-side cover 47 of torque converter 6 is likewise essentially disk-shaped and features second rim 53 with second tooth system 55.

Coupling spring device 43 meshes, in a form-closed manner, with first tooth system 51 of first rim 49 and with second tooth system 55 of second rim 53. As a result, piston 28 is coupled non-rotatably with housing 10 of the torque converter. Piston 28 is connected with housing 10 on the converter-side, radially outside by means of coupling spring device 43 under axial prestress. Advantageously, friction disk 29 projects into the radial design space still required for coupling, according to the illustration of FIG. 1; thus, it is also lengthened nearly up to housing wall 14, through which a larger effective radius of torque converter lockup clutch 26 is advantageously obtained. The friction linings or friction surfaces of torque converter lockup clutch 26 are disposed adjacently to radial external housing wall 14. This is possible, since coupling spring device 43 is disposed within the converter-side design space between piston 28 and turbine wheel 21.

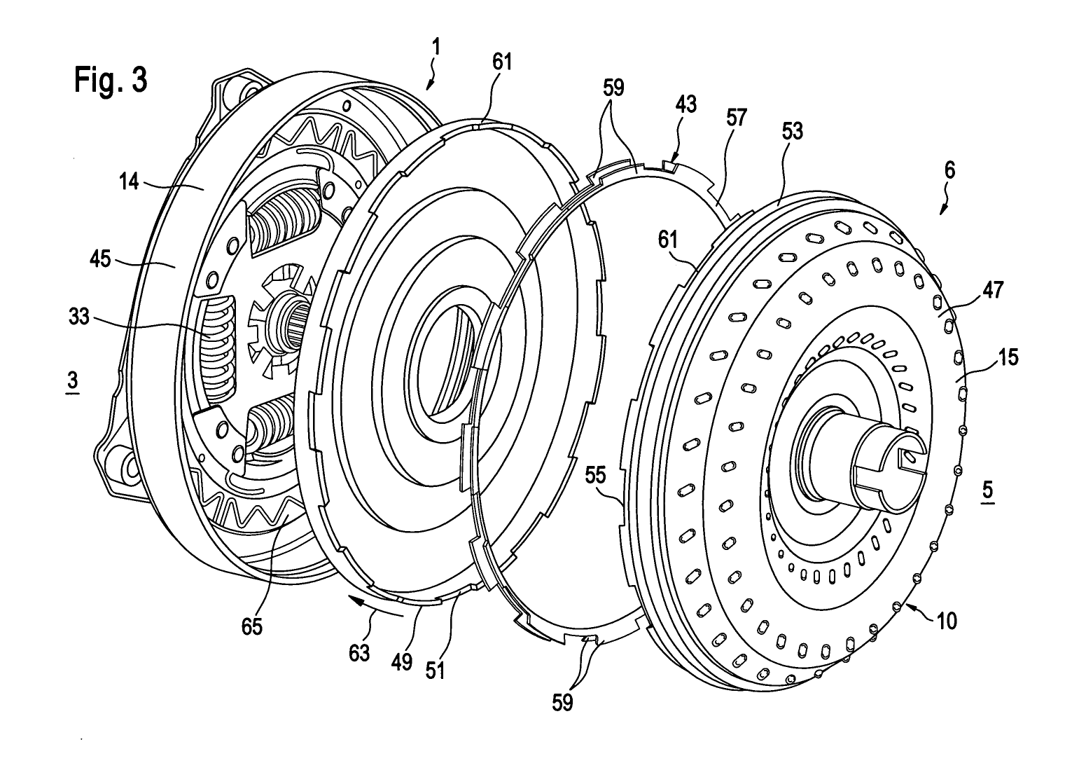

FIG. 3 shows a three dimensional exploded view of torque converter 6 depicted in FIG. 2 obliquely from the front. It is apparent that coupling spring device 43 features drive synchronizer spring 57. Drive synchronizer spring 57 features V-shaped spring elements 59 on the opposite side. In the assembled state, spring elements 59 can be brought onto abutments 61 of the corresponding first and second tooth system 51 and 55, respectively, and thus under prestress. By means of arrow 63 it is hinted that spring elements 59 of drive synchronizer springs 57 keep piston 28 under prestress via abutments 61 which act on friction surface 65 of drive-side cover 45.

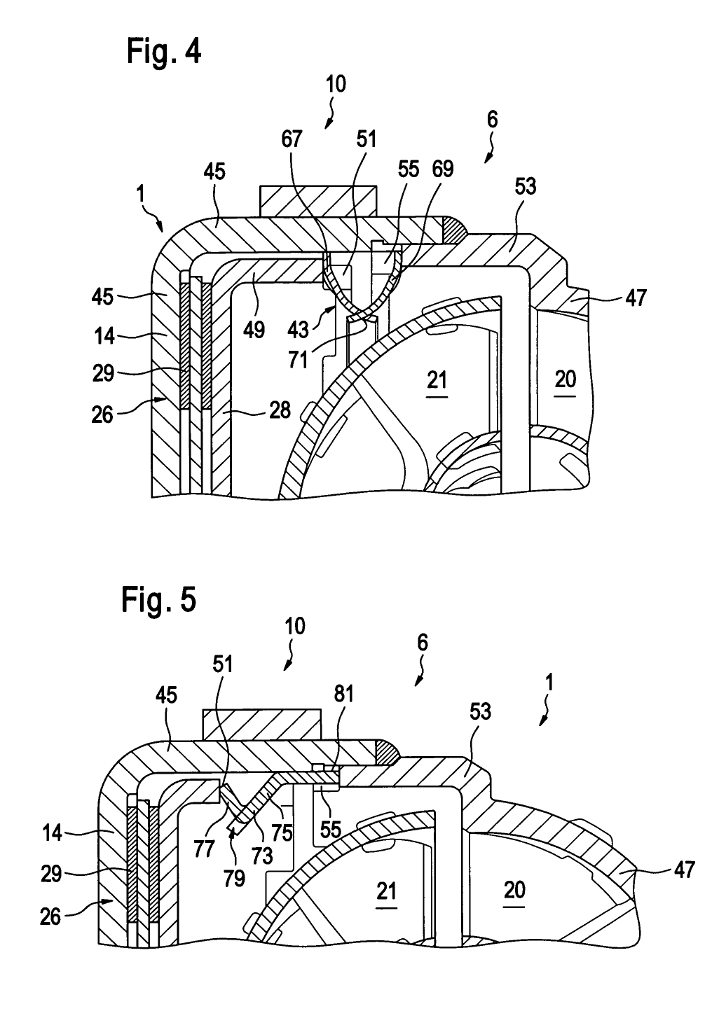

FIG. 4 shows a longitudinal section of a detail of torque converter 6 with a further coupling spring device 43 which features drive-side diaphragm spring 67 as well as converter-side diaphragm spring 69. Drive-side diaphragm spring 67 meshes with first tooth system 51 of first rim 49. Converter-side diaphragm spring 69 meshes with second tooth system 55 of second rim 53 of converter-side cover 47. For non-rotatable coupling of piston 28 with housing 10, diaphragm springs 67 and 69 moreover feature tooth system 71 respectively, through which diaphragm springs 67 and 69 can be coupled mutually non-rotatably. The torque flow occurs also, starting from second rim 53 via tooth systems 55, 71 and 51 and finally to first rim 49 of piston 28.

FIG. 5 shows a detail view of a further torque converter 6 with diaphragm spring ring 73. Diaphragm spring ring 73 features annular spring leaf 75. Spring leaf 75 of diaphragm spring rings 73 features bent sections 77 which realize tooth system 79. For non-rotatable coupling of piston 28 with second rim 53 of converter-side cover 47, tooth system 79 meshes with first tooth system 51 of first rim 49 of piston 28. On the opposite side, spring leaf 75 features tooth system 81 which meshes with second tooth system 55 of converter-side cover 47. Thus, via a single component, namely diaphragm spring ring 73, its spring leaf 75 and tooth systems 79 and 81, non-rotatable coupling and prestress of piston 28 as well can occur advantageously.

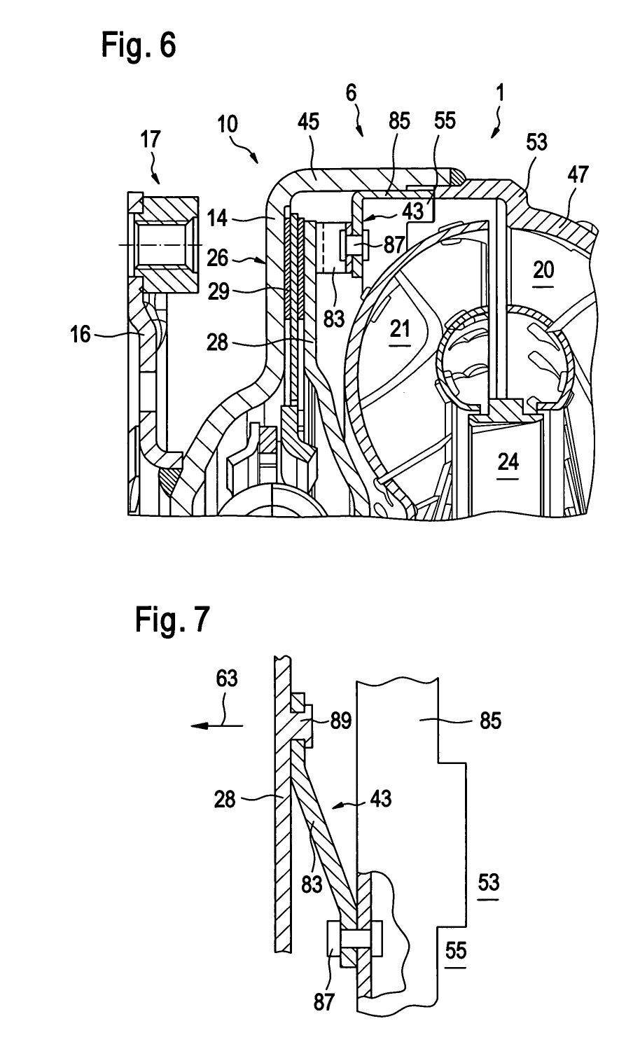

FIG. 6 shows a further longitudinal section of a detail view of torque converter 6 with leaf spring 83 and disk-shaped catch 85. Disk-shaped catch 85 meshes with second tooth system 55 of the converter-side cover of housing 10. Catch 85 is non-rotatably attached to leaf spring 83, wherein the attachment occurs via rivet 87. Leaf spring 83 is attached to piston 28 under prestress.

FIG. 7 shows a partially broken illustration, viewed in the alignment of FIG. 6, from the top with a partial auxiliary section and a partial section of carrier 85 of leaf spring 83 and of piston 28 as well. Through the auxiliary section, rivet 87 is visible. The attachment of leaf spring 83 to piston 28 takes place likewise via rivet 89. Arrow 63 hints at the direction of force of leaf spring 83 necessary to prestress piston 28.

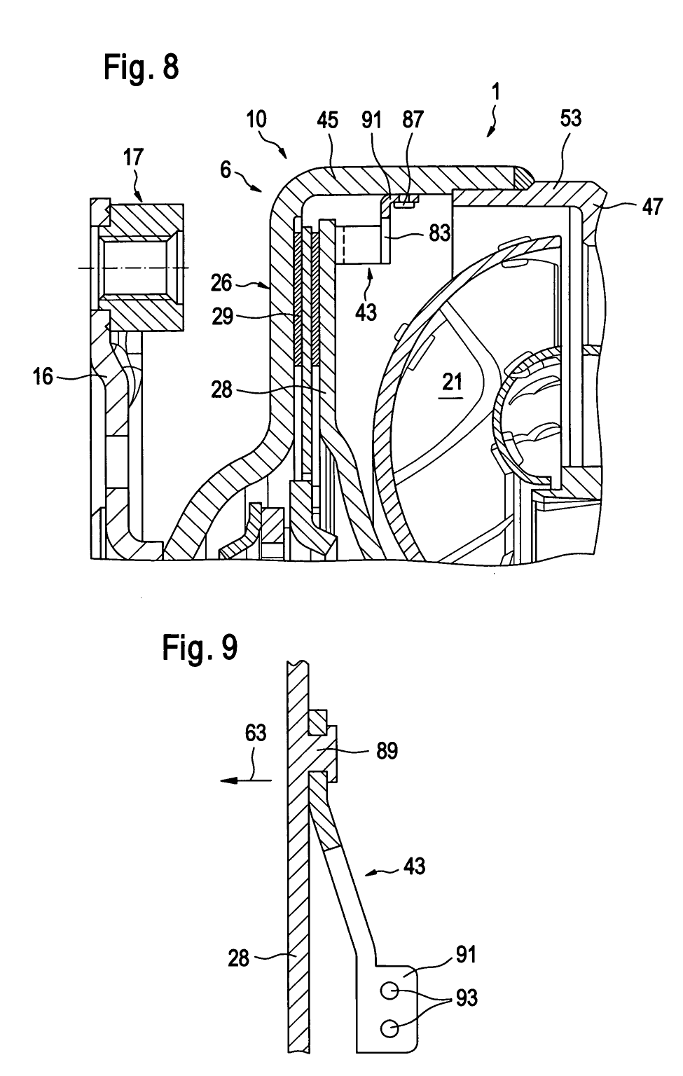

FIG. 8 shows a further sectional illustration of a detail of torque converter 6 with leaf spring 83. In contrast to the illustration according to FIGS. 6 and 7, no catch 85 is provided according to FIG. 8. Instead of carrier 85, leaf spring 83 features bent fixing plate 91. Leaf spring 83 can be attached directly on drive-side cover 45 by means of fixing plate 91 and rivet 87.

FIG. 9 shows a sectional illustration of leaf spring 83, viewed in the alignment direction of FIG. 8, from the bottom onto fixing plate 91, wherein the cutting plane runs through rivet 89 of leaf spring 83 with piston 28. In FIG. 9, drive-side cover 45 and rivet 87 are not depicted. Fixing plate 91 features two bores 93, in which two rivets 87 can be fixed.

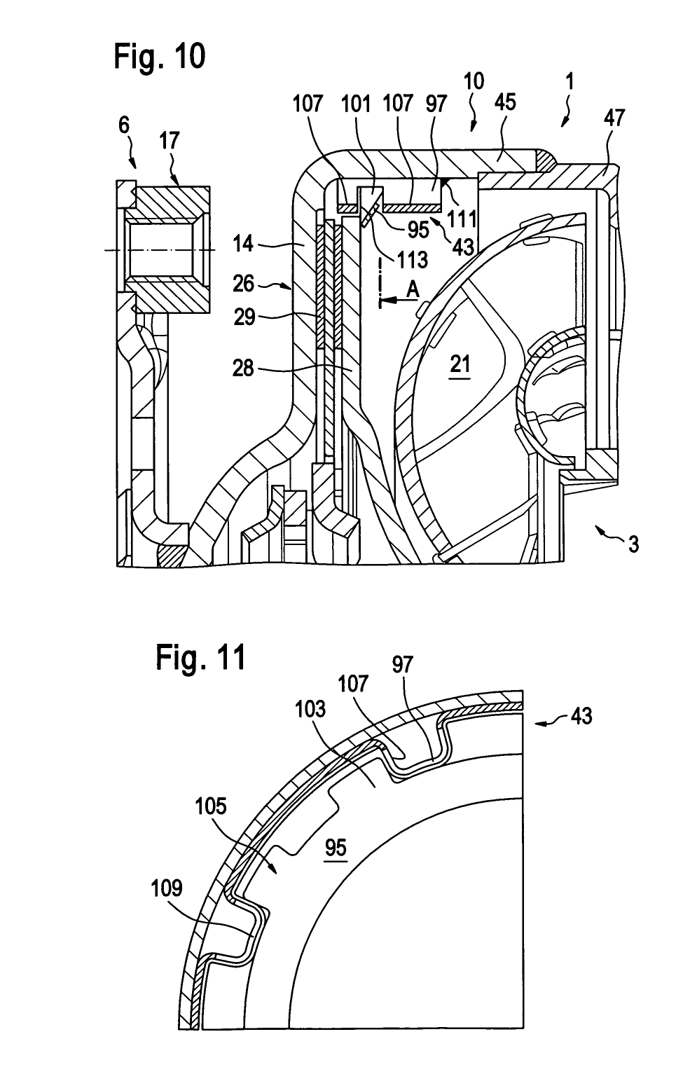

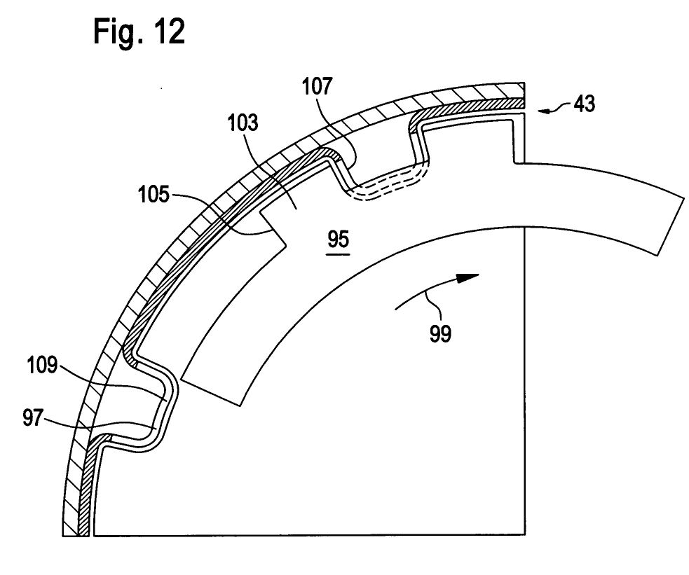

FIG. 10 shows a further longitudinal section of a detail view of torque converter 6 with diaphragm spring ring 95 and disk carrier 97 as well. FIGS. 11 and 12 show a plan view of diaphragm spring ring 95 and disk carrier 97 as well viewed from the direction of arrow A from FIG. 10. FIG. 11 shows the diaphragm spring ring in the applied state within disk carrier 97.

FIG. 12 shows diaphragm spring ring 95 after a partial rotary motion which is hinted by arrow 99. In FIG. 12 it is apparent that diaphragm spring ring 95 can be held analogously to the functioning manner of a bayonet closure, in a form-closed manner, within recess 101 of the disk carrier. To execute a rotation, as hinted by arrow 99, the diaphragm spring ring must first be brought under prestress in the drawing plane of FIGS. 11 and 12 so that teeth 103 of tooth system 105 of diaphragm spring ring 95 can slide through recess 101 of disk carrier 97. Recess 101 is formed by cutouts 107 located opposite of disk carrier 97. Furthermore, a tooth system of disk carrier 97 is realized by cutouts 107. Tooth system 109 of disk carrier 97 serves on the one hand for bayonet-closure type of fixation of diaphragm spring ring 95, as already described, and on the other hand for non-rotatable coupling of piston 28 with drive-side cover 45 of housing 10. Here, for instance, disk carrier 97 is non-rotatably attached to drive-side cover 45 by means of weld 111. For axially relocatable, non-rotatable coupling of piston 28, tooth system 109 of disk carrier 97 moreover meshes with tooth system 113 of piston 28.

For assembly, first piston 28 can be inserted inside drive-side cover 45. Afterwards, diaphragm spring ring 95, as described above, can be mounted like a bayonet closure, so that it interlocks in disk carrier 97. The diaphragm spring ring can rest on disk carrier 97 in order to generate the required prestress and at the same time it is secured against rotation. The direction of prestress force which acts through piston 28 corresponds to the direction of view as hinted by arrow A.

### REFERENCE LIST

1 power train
3 drive unit
5 transmission
6 torque converter
10 housing
12 rotation axis
14 housing wall
15 housing wall
16 connection plate
17 starter ring gear
20 impeller
21 turbine wheel
22 turbine wheel hub
23 input shaft/drive shaft
24 guide vanes
26 torque converter lockup clutch
27 torsional vibration damper
28 piston
29 friction disk
30 clutch disk
33 energy storage element
35 damper flange
36 welded connection
38 damper hub
41 leaf spring
43 clutch spring device
45 drive-side cover
47 converter-side cover
49 first rim
51 first tooth system
53 second rim
55 second tooth system
57 drive synchronizer spring
59 spring elements
61 abutment
63 arrow
65 friction surface
67 drive-side diaphragm spring
69 converter-side diaphragm spring
71 tooth system
73 diaphragm spring ring
75 spring leaf
77 bent section
79 tooth system
81 tooth system
83 leaf spring
85 catch
87 rivet
89 rivet
91 fixing plate
93 bore
95 diaphragm spring ring
97 disk carrier
99 arrow
101 recess
103 teeth
105 tooth system
107 cutout
109 tooth system
111 weld
113 tooth system

What we claim is:

1. A hydrodynamic torque converter comprising:
a housing;
a driving impeller;
a driven turbine wheel rotatably disposed in said housing and adapted to be attached to an output shaft of a drive unit, wherein said driven turbine wheel is positioned adjacent to a turbine-side of said housing; and,
a torque converter lockup clutch comprising a piston non-rotatably connected to said housing via a coupling spring device, wherein said piston is movably connected to said housing in an axial direction and is connected to said housing radially outside on said turbine-side via said coupling spring device.

2. The hydrodynamic torque converter according to claim 1, wherein said coupling spring device is interposed between said piston and a converter-side cover of said housing, said piston comprises a first rim with a first tooth system and said converter-side cover comprises a second rim with a second tooth system.

3. The hydrodynamic torque converter according to claim 2, wherein said coupling spring device comprises a drive synchronizer spring having V-shaped spring elements disposed oppositely, said V-shaped spring elements mesh with said first and second tooth systems.

4. The hydrodynamic torque converter according to claim 2, wherein said coupling spring device comprises a drive-side diaphragm spring arranged to mesh with said first tooth system, a converter-side diaphragm spring arranged to mesh with said second tooth system and said drive-side and converter-side diaphragm springs are non-rotatably coupled to each other.

5. The hydrodynamic torque converter according to claim 1, wherein said coupling spring device comprises a diaphragm spring ring.

6. The hydrodynamic torque converter according to claim 5, wherein said diaphragm spring ring is arranged to mesh with said first and second tooth systems.

7. The hydrodynamic torque converter according to claim 5, wherein said diaphragm spring ring is attached directly to said housing via a disk carrier.

8. The hydrodynamic torque converter according to claim 7, wherein said diaphragm spring ring is insertable inside said disk carrier in a form-closed manner.

9. The hydrodynamic torque converter according to claim 1, wherein said coupling spring device comprises a leaf spring.

10. The hydrodynamic torque converter according to claim 9, wherein said leaf spring is attached to a disk-shaped catch and said piston.

11. The hydrodynamic torque converter according to claim 1, wherein said coupling spring device is connected with said housing under axial prestress.

12. A torque transmission device disposed in a power train of a motor vehicle and arranged for torque transmission between a drive unit and a transmission, said torque transmission device comprising the hydrodynamic torque converter according to claim 1.
